(19) United States
(12) Patent Application Publication
(10) Pub. No.: US 2020/0082722 A1
(43) Pub. Date: Mar. 12, 2020

(54) SYSTEMS AND METHODS FOR IMPROVING THE DETECTION OF LOW-ELECTROMAGNETIC-PROFILE OBJECTS BY VEHICLES

(71) Applicant: Ben Zion Beiski, Kirya Ono (IL)

(72) Inventor: Ben Zion Beiski, Kirya Ono (IL)

(21) Appl. No.: 16/526,111

(22) Filed: Jul. 30, 2019

Related U.S. Application Data
(60) Provisional application No. 62/752,373, filed on Oct. 30, 2018.
(60) Provisional application No. 62/728,884, filed on Sep. 10, 2018.

(51) Int. Cl. G08G 1/16; G06K 7/10; G06K 19/07; G01S 13/75; G01S 13/93

(52) U.S. Cl. CPC G08G 1/161; G06K 7/10366; G06K 19/0723; G01S 13/865; G01S 13/931; G01S 2013/9339; G01S 13/75

(57) ABSTRACT

A system and a method are disclosed for improving the performances and safety of vehicles' navigation control systems by increasing the detectability and the information of low-electromagnetic-profile objects, such as road signs, children, and the like. The disclosed method includes a radar reflector and a passive, active or continuously-programmable RFID tag attached to the low-electromagnetic-profile objects and an RFID reader added to the vehicle and connected to its navigation control system. The RFID tags store in their memory relevant information about the object, which is retrievable by the interrogating reader, providing the navigation control system, in real-time, vital identifying information about the characteristics of the low-electromagnetic-profile object in addition to its position relative to the vehicle.

### CROSS-REFERENCE TO RELATED APPLICATION

This application claims the benefit of priority of U.S. provisional application Nos. 62/728,884 and 62/752,373, filed 10 Sep. 2018 and 30 Oct. 2018, respectively, the contents of which are herein incorporated by reference.

### BACKGROUND OF THE INVENTION

The present invention relates to navigation systems for autonomous vehicles and, more particularly, to a system for improving the capabilities of partially or fully autonomous vehicles by adding dedicated RFID tags and/or a radar reflector to low-electromagnetic-profile objects that the vehicle may encounter while trying to navigate using only its own instrumentation.

A vehicle trying to navigate using its sensors may encounter numerous low-electromagnetic-profile objects such as a bicycle, motorcycle, livestock animals, pets, horses, children, road-side posts, stop-sign, traffic light, policeman, round-about, and the like. Undetected objects and/or misidentification of those object can hamper the vehicle's navigation system and cause very serious safety issues.

Modern vehicles are controlled partially or fully by a control system that gets information of surrounding objects by an array of sensors, e.g., optical, visual, RF-based, etc. Future transportation technologies will rely even more significantly on such sensors to detect the surrounding objects and guide the vehicle safely. However, the information sensed by the vehicle's sensors can be misleading; for example, an object like a soda can produce a radar image far out of proportion to its size, while a plastic road-side post or a child can produce a radar image much smaller than it is. Moreover, relying on information that is received from external networks (cellular, Wi-Fi, Bluetooth, BLE, proprietary, VANET and the like) can cause serious safety issues due to communication speed, accuracy and reliability issues, etc.

Therefore, increasing automation levels requires a system that can accurately sense and analyze complex scenarios so as to correctly respond to multiple potential hazards in real-time. Moreover, fast-moving vehicles require fast, real-time and accurate information.

One of the most prominent issues that autonomous (or semi-autonomous) vehicle technology faces is the inability to detect and react to cyclists (as an example of low-electromagnetic-profile objects) in biking lanes or who share the road with vehicles. Though, cyclists are not the only objects that the vehicles' sensors find difficult to detect. A vehicle encounters many other objects with low-electromagnetic profile; children, motorcycles, pets, horses, pigs, bulls, guardrails (specifically non-metal), pedestrians, traffic-light, road-side signs, roundabout, etc. (and any combination thereof), whereby such low-electromagnetic profile objects are often not detected, or their detection is misidentified—i.e., their perceived electromagnetic profile is different than what is identified. Even visual sensors like cameras or IR sensors can often be misleading when sensing children, for example.

A vehicle trying to navigate by relying solely on information coming from its sensors must have accurate information on all surrounding objects based in at least in part on such object's electromagnetic profile, or more specifically its Radar Cross Section (RCS). This radar reflection/emission is also known as a “radar fingerprint” or “radar signature”. Again, such navigation cannot be flawlessly achieved, however, because some objects have a low electromagnetic profile. On the other hand, if the surrounding objects could identify their “nature” (i.e., who am I? How big I am? my status, etc.) in addition to their accurate, real-time position, the overall effectiveness and safety of the vehicle could be significantly improved. Especially in an urban environment where the density and diversity of objects are very challenging, optimal performance requires reliable, accurate and fast detection methods of all the objects, including those with low-electromagnetic profiles.

Nowadays, five major classes of vehicular sensors provide the lion's share of environment sensory data for vehicle control. Those sensors include:

(1) Short, medium and long-range radars;

(2) Light Detection and Ranging (hereafter LIDAR);

(3) Image sensors (mainly cameras in the infrared and visual bands);

(4) Ultrasound; and

(5) Cameras, and the like and any combination thereof.

Radar-based systems that are typically employed in automotive active safety systems can be subdivided into three major classes:
(i) Short-range radar (SRR) for collision proximity warning and safety, and to support limited parking assist features;
(ii) Medium-range radar (MRR) to watch the corners of the vehicle, perform blind spot detection, observe other-vehicle lane crossover and avoid side/corner collisions; and
(iii) Long-range radar (LRR) for forward-looking sensors, adaptive cruise control (ACC) and early collision detection functions.

Failing to detect the surrounding objects affects the decisions the vehicle control unit makes, and the consequences could be dire-particularly if the car is relying on that information to navigate and avoid crashing into them. As an example, a small child standing next to a vehicle can become “invisible” to a radar receiver. Moreover, the growing use of; composite material like carbon-fiber in the structures like frames of bicycles and motorcycles, in addition to the prevalence of plastic-based parts (in roadside signs and vehicles), decreases those objects electromagnetic profile even more. This is because radar-based sensors rely on the reflected, electromagnetic radiation from the object to be detected. The effectiveness of any radar-based system depends on the reflected, electromagnetic radiation. Low-reflected, electromagnetic radiation impairs the effectiveness of any radar-based sensor significantly. This phenomenon is used (but to achieve the opposite effect) by stealth aircraft which are designed to avoid detection using a variety of technologies that reduce reflection/emission of radars.

A variety of methods in use by vehicle radar systems; Long Range Radar (LRR) systems operate in the 77 GHz frequency band (76-81 GHz), the broadband Frequency Modulated Continuous Wave (FMCW) that combines high resolution in range and depth perception, with the detection of objects in a small radar cross-section, automatic emergency braking system (AEBS) and adaptive cruise control (ACC).

Bicycles, as an example, pose a complex detection problem because they are relatively small, fast and heterogenous, unlike a car which is a big block of stuff. A bicycle has significantly less mass (mainly metal) and usually has multiple variations in appearance: i.e., there are more shapes, colors, material compositions, and stuff attached to bicycles. Tests have shown that today's systems spot only 74 percent of bikes vs. 88 percent of the vehicle. Current technology for vehicle control (partially or full-self-driving cars) thus faces an inability to detect and react to cyclists in biking lanes or who share the road with vehicles. Bicycles are much less predictable, nimbler than cars because it's easier for them to make sudden turns or jump out of nowhere. A 2017 study by the IEEE Spectrum found that out of all forms of transportation that autonomous cars interact with, self-driving car technology has the most difficulty detecting bicycles.

As can be seen, there is a need for a system for improving the capabilities of partially or fully autonomous vehicles by adding dedicated RFID tags and/or a radar reflector to low-electromagnetic-profile objects that the vehicle may encounter while trying to navigate using only its own instrumentation. The system and methods of the present invention offer a very low-cost solution through incorporating a reflector and/or RFID to the bicycle, as an example of an object with a low electromagnetic profile. The reflector bounces back the radar signals of the vehicle and the RFID respond to the vehicle RFID reader with information on its identification; “I'm a bicycle”, “my correct position is . . . ”, “my current speed is . . . ”, “my direction is . . . ”, and the like.

While today, an autonomous (semi or full) vehicle relies only on its sensors and their processing power at their control unit for road objects detection and identification, the disclosed systems and methods of the present invention give real-time and accurate information from low-electromagnetic-profile objects it may encounter, in a very reliable manner and at an affordable price. The information is added to the vehicle's existing control system inputs and improves the accuracy and safety of the vehicle's navigation mainly for semi or fully autonomous vehicles.

The system and method of the present invention can be small in size, low cost, weatherproof, immune to cyber-attacks, powerless (passive) and consume very limited power that is needed in active or continuously programmable RFID versions. Its power, if needed, can be supplied by a battery and/or a solar cells panel, wind turbine, or the like, thereby enabling implementation of this technology in remote areas without a connection to the electrical grid. Due to its low cost it is very affordable even for low-cost objects (such as basic road-side plastic warning sign). The system of the present invention (the passive version RFID) is immune to any hacking attacks as its data can't be modified online, unlike many IoT (Internet of Things) devices. Moreover, it is very simple to implement and install and requires very low maintenance if any.

Increasing an object's electromagnetic signature and/or its identification can be subdivided into two basic methods; passive and active. A passive method uses the energy coming from the transmitting device only. In the active devices, the reflected signal is enhanced (amplified), or triggering action that is received by the transmitting device.

### SUMMARY OF THE INVENTION

In one aspect of the present invention, a method for improving a vehicular navigation control system includes the following: providing a vehicle having a navigation control system; connecting an RFID reader to the vehicle and operatively associated to said navigation control system; and attaching one or more reflectors to at least one object having a low radar cross-section, wherein each reflector increases the radar cross-section; coupling one or more RFID tag to each object, wherein each RFID tag retrievably stores an identification data comprising a nature of said object; and said nature being irrespective of a position of said object, wherein the RFID reader is configured to interrogate every RFID tag within an operable range so that the RFID tag discloses the identification data.

In another aspect of the present invention, a method of creating a vehicular ad-hoc network includes the following: providing a plurality of vehicles incorporating the above-mentioned method; and each navigation control system configured to share the identification data of each object with each vehicle beyond the operable range; a traffic module coupled to each navigation control system, wherein the traffic module comprises a status of traffic regulation in the operable range, and wherein the traffic module is coupled to the identification data of each object.

These and other features, aspects and advantages of the present invention will become better understood with reference to the following drawings, description and claims.

### BRIEF DESCRIPTION OF THE DRAWINGS

FIG. 1—illustrates an example of how the system of the present invention is mounted on a bicycle and interacts with a vehicle on the road.

FIG. 2—illustrates in block diagram form a general structure of the system, only the part mounted on the low electromagnetic profile object part, of the present invention in its passive RFID version.

FIG. 3—illustrates in block diagram form a general structure of the system, only the part mounted on the low electromagnetic profile object part of the present invention in its active RFID version.

FIG. 4—illustrates in block diagram form a general structure of the system, only the part mounted on the low electromagnetic profile object part, of the present invention in its continuously-programmable RFID version.

FIG. 5—illustrates in block diagram form a general structure of the frequency allocation bands including the frequency bands allocated for the automotive industry.

FIG. 6—illustrates in diagram form a general structure of typical-vehicle sensors setup and functionality.

FIG. 7—illustrates in diagram form a general structure of a typical sensors' setup in a vehicle.

FIG. 8—illustrates in diagram form a general concept and functionality of a typical corner-reflector.

FIG. 9—illustrates in diagram form a general structure of a typical multi-directional corner reflector with an RFID tag placed in one location.

FIG. 9a—illustrates in diagram form a general structure of a typical multi-directional corner reflector with multi RFIDs (tags or antennas only) each one placed in a different direction.

FIG. 10—illustrates an example to the improvement in the radar cross-section reflection achieved by a corner reflector. It shows the radiation pattern of the triangular trihedral corner reflector in the azimuth and elevation planes.

FIG. 11—illustrates in diagram form a general structure of a typical setup of the system of the present invention on a bicycle.

FIG. 12—illustrates in diagram form a general structure of a typical RFID system and an additional embodiment of connecting a GPS information (fixed or alternating) to the RFID tag.

FIG. 13—illustrates in diagram form a general structure of a typical setup of the system of the present invention installed on examples of objects a vehicle may encounter such as; a pig, a bull/cow, a sheep, a doc (a pet), a horse, a child, road signs (of all kinds), a scooter, a policeman, a traffic light, and the like—all as examples and in any combination thereof. The black dots show the optional placement of the reflector and/or RFID tag in those sample objects.

FIG. 14—illustrates in diagram form an example of the system of the present invention and how it can be integrated into a traffic light at a 4-way junction.

FIG. 15—illustrates in diagram form a general structure of a typical setup of the system of the present invention installed in a vehicle control system

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and methods for improving the performances and safety of vehicles' control systems by increasing the detectability and the information of low-electromagnetic-profile objects, such as road signs, children, and the like, by the vehicle's control-system sensors. The disclosed systems and methods of the present invention includes radar reflectors and RFID tags (passive, active or continuously-programmable) attached to low-electromagnetic-profile objects on one end, and radars, cameras and RFID readers (also known as an interrogator) added to the vehicle and connected to its control system on the other end.

The system includes radar reflectors and RFID tags attached to low-electromagnetic-profile objects and storing in their memory the relevant information about the object. The vehicle is equipped with radars, cameras and one or more RFID interrogators. The low-electromagnetic-profile objects reflect more effectively the radar signals and respond to interrogation by an RFID reader, providing, in real-time, vital information about the characteristics of the low-electromagnetic-profile object, like, nature, position, status, and the like, to the interrogating vehicle control system.

It should be understood that the definition of the following words and terms having the following meanings:

The terms “about” and “essentially” mean±10 percent.

The terms “a” or “an,” as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, (i.e., one or more methods, devices, or apparatuses for achieving the desired function) and that one skilled in the art could select from these or their equivalent in view of the disclosure herein, and use of the term “means” is not intended to be limiting.

### Passive Devices—Radar Reflectors

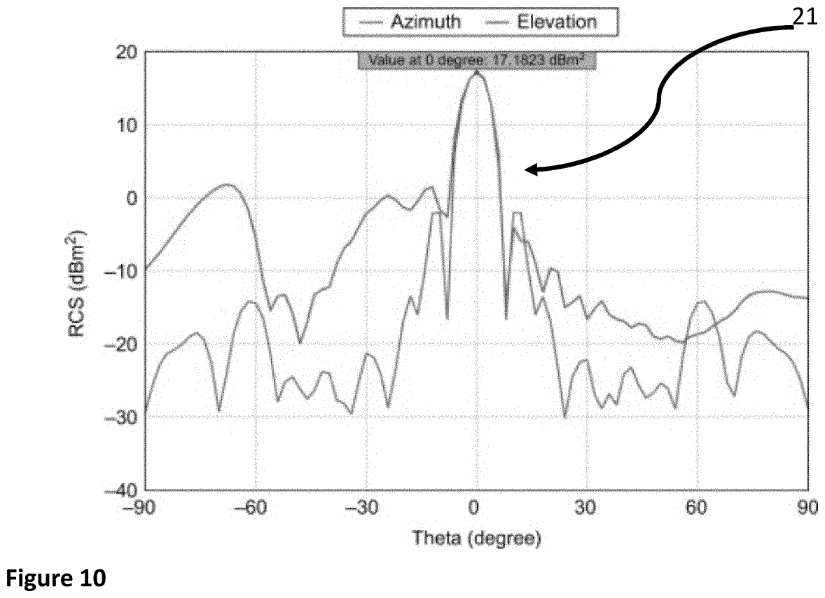

A radar reflector is aimed at effectively reflecting incoming radar electromagnetic signals. An example of a very effective passive reflector is the light reflector used in multiple devices, such as reflective safety vests, road-side posts, reflective safety warning conspicuity tape (typically in yellow or orange color), running shoes, and many more. Radar reflectors function in a very similar manner to optical reflectors, that can be found in safety vests, road-side reflectors, bicycle, and the like, but aims for different wavelengths (i.e., not in the visible band but in the RF band). An example of such reflector is a “corner reflector” (Dihedral, trihedral or octahedral types). Corner reflectors are used to generate a particularly strong radar echo from objects that would otherwise have only very low effective Radar Cross Section (RCS). Corner reflectors can reflect back stronger radar signal at about 20 dB or more than square plate, and even more comparing to objects with non-even, non-metallic surfaces (see FIG. 10). RCS is the measure of a target's ability to reflect radar signals in the direction of the radar receiver. RCS is computed by the exact solution for the Corner reflector length

RCS=(πL4)/(3λ2)
RCS in dBsm is computed by taking: 10 log*(RCS [meters2])

Corner reflectors are typically a metal pyramid 13 with the base removed. Energy enters the pyramid and reflects out in a concentrated beam, hence increasing the radar cross-section in that direction. A multidirectional-corner reflector includes two or three electrically conductive surfaces which are mounted crosswise (at an angle of exactly 90 degrees). Incoming electromagnetic waves are backscattered by multiple reflections accurately in that direction from which they come. Thus, even small objects with small RCS yield a sufficiently strong echo. It is in use very extensively by small vessels and is typically installed on the mast.

The single areas of the corner reflector should be large compared to the radar wavelength. The larger a corner reflector is, the more energy is reflected. It can also be constructed in resonance with the radar wavelength. This will increase the echo signals again. To reduce losses caused by other objects, corner-reflectors are mounted as high as possible.

### RFID—Radio-Frequency Identification

RFID tags 25 use electromagnetic fields to automatically identify and track the object it is attached to. The tags contain electronically-stored information (which can be a unique identification (ID) or other information such as GPS position, descriptive ID, and the like which can be programmed, stored or changed by a local processor.

The system of the present invention can use at least three types of RFID tags: a) Passive, b) Active and c) Continuously-Programmable RFID with a single or double buffer memory to allow updating the tag's data continuously.

### RFID—Passive

In its passive version, the RFID transmitted signal from the reader (also known as the ‘reader’) is modulated and reflected back to the reader with the ID information. Passive tags collect energy from a nearby RFID reader's interrogating radio waves.

### RFID—Active Device

RFID—Active tags have a local power source (such as a battery or a solar cell) and have a longer range of operation up to hundreds of meters from the RFID reader. Active RFID is more effective also to fast-moving objects, like an in electronic toll-road. Two different types of active RFID tags are available —transponders and beacons.

Transponders—In a system that uses an active transponder tag, the reader (like in the passive systems) will send a signal first, and then the active transponder will send a signal back with the relevant information. Transponder tags are very efficient because they conserve battery life when the tag is out of range of the reader. Active RFID transponders are commonly used in secure access control and in toll booth payment systems.

Beacons—In a system that uses an active beacon tag, the tag will not wait to hear the reader's signal. Instead, true to its name, the tag will ‘beacon’, or send out its specific information every 3-5 seconds. Beacon tags are very common in the oil and gas industry, as well as mining and cargo tracking applications. Active tag's beacons can be read hundreds of meters away, but in order to conserve battery life, they may be set to a lower transmit power in order to reach around 100 meters read range.

Tags antenna types—the two most common antenna types for an RFID tag is linear- and circular-polarized antennas. An active RFID tag has the advantages of a) longer responds range (usually up to 300 meters) and b) better performances for fast-moving vehicles. Electronic toll road RFIDs typically are active RFID due to the vehicle speed that poses detection difficulties to passive RFIDs.

### Typical RFID Frequencies are:

RFID FREQUENCY BAND/SPECTRUM ALLOCATION

| RFID | FREQUENCY | | |
|---|---|---|---|
| FREQUENCY | BAND | TYPICAL | |
| BAND | DESCRIPTION | RANGE | TYPICAL RFID APPLICATION |
| 125- | Low frequency | Up to | These frequencies can be used globally without a license. Often used for vehicle identification. |
| 134.2 kHz | | ~½ | Sometimes referred to as LowFID. |
| and 140- | | metre | |
| 148.5 kHz | | | |
| 6.765- | Medium | | Inductive coupling is used on these RFID frequencies. |
| 6.795 MHz | frequency | | |
| 13.553- | High Frequency | Up to | These RFID frequencies are typically used for electronic ticketing, contactless payment, access |
| 13.5647 MHz | HF Often | ~1 metre | control, garment tracking, etc |
| | called 13.56 | | |
| | MHz | | |
| 26.957- | Medium | Up to | Inductive coupling only, and used for special applications. |
| 27.283 MHz | frequency | ~1 metre | |
| 433 MHz | UFH | | These RFID frequencies are used with backscatter coupling, for applications such as remote car |
| | | | keys in Europe |
| 858- | Ultra High | 1 to 10 | These RFID frequency cannot be accessed globally and there are significant restrictions on |
| 930 MHz | Frequency | metres | their use. When they are used, it is often used for asset management container tracking, |
| | UFH | | baggage tracking, work in progress tracking, etc. and often in conjunction with Wi-Fi systems. |
| | | | For further information on its use see the paragraph below. |
| 2.400- | SHF | | Backscatter coupling, but only available in USA/Canada |
| 2.483 GHz | | | |
| 2.466- | SHF | 3 metres | These RFID frequencies are used for long range tracking and with active tags, RFID and AVI |
| 2.454 GHz | | upwards | (Automatic Vehicle Identification). Backscatter coupling is generally used. |
| 5.725- | SHF | | Backscatter coupling. Not widely used for RFID. |
| 5.875 GHz | | | |

### VANET, V2V—Vehicle-to-Vehicle, V2R—Vehicle-to-Roadside, V2I—Vehicle-to-Infrastructure

The VANET protocol is specifically designed to work in an environment without infrastructure where all the vehicles (nodes) can talk to each other (ad-hoc network) and collaboratively generate information about the traffic conditions existing at that moment in a given environment. The disclosed systems and methods of the present invention can be integrated into VANET where the vehicles share the information they picked from the objects (ID, location, etc.) and share it with the neighboring vehicles, via VANET or other similar data-sharing network. Other elements in the disclosed systems and methods of the present invention and are integrated into the vehicle control system as another input.

The system of the present invention can also be integrated with a vehicle-to-vehicle (V2V), vehicle-to-roadside (V2R), Vehicle to Infrastructure (V2I) by becoming an active node in the network with an additional WiFi/WiMax/Bluetooth and the like, communication channels.

A Vehicular Ad-Hoc Network or VANET is a technology that uses moving vehicles as nodes in a network to create a mobile network. VANET turns every participating vehicle into a wireless router or node, allowing vehicles approximately 100 to 300 meters of each other to connect and, in turn, create a network with a wide range. As vehicles fall out of the signal range and drop out of the network, other vehicles can join in, connecting vehicles to one another so that a mobile Internet is created. VANET is a subgroup of MANET where the nodes refer to vehicles. Since roads restrict the movement of vehicles, traffic regulations create a fixed infrastructure at critical locations which can be leveraged by VANET. The primary goal of VANET is to provide road safety measures where information about the vehicle's current speed, location coordinates are passed with or without the deployment of Infrastructure.

Communication Types
Vehicle to Vehicle (V2V)
Vehicle to Infrastructure (V2I)
Vehicle to Roadside (V2R)

Vehicle to Infrastructure/Roadside Communication (v2i/v2r)
Vehicle to Infrastructure provides a solution to longer-range vehicular networks.
It makes use of pre-existing network infrastructure such as wireless access points (Road-Side Units—RSUs).
Communications between vehicles and RSUs are supported by Vehicle-to-Infrastructure (V2I) protocol and Vehicle-to-Roadside (V2R) protocol.

Technologies Used
Sensor technologies (Infra-red sensing/Video and Camera Image Perception/RADAR/gyro sensor/inertial sensor), process data through mathematical algorithms to come up with a virtual understanding of the vehicle environment
In-vehicle digital maps and positioning technologies (GPS/Wi-Fi/WiMAX) utilize sensing systems to accurately identify the vehicle position and interpret the environment
If there is a gridlock/high traffic density detected by a roadside infrastructure, then the roadside system can broadcast the information to all its nodes/vehicles
In turn, using the DTN capabilities of VANETs, the information can be transmitted to other vehicles heading towards this junction.
Likewise, it can convey to the incoming vehicles other paths, depending on centralized system co-ordination of finding non-traffic routes at that point of time.

Dedicated Short Range Communication (DSRC)
VANET Active Safety of Passengers and more reliable
802.11p Add wireless access to vehicular networks and implements OSI stack
Wireless Protocol with a Licensed band of 5.9 GHz, seven channels, Range of 1000 m, Data rate 6 to 27 Mbps
Mainly used in the communication of
   1) Vehicle to Vehicle
   2) Vehicle to Roadside

IEEE 802.11p, a protocol belonging to the IEEE 802.11 family.

Kashif Ali et al. (Reference document no. 1), teaches about installing a Passive-RFID tag to non-intelligent vehicles (non-IVs), in order to assists in their detection by the vehicle's control system, but do not teach about adding a passive RFID tag nor actives RFID to other objects.

A. Vanitha Katherine et al. (reference document No. 2) teaches about using RFID as a means of communication between vehicles (V2V) with VANET concept.

Vehicular Ad-hoc Networks (VANETs) and cooperative collision avoidance (CCA) communication systems for cooperative collision warning and vehicle's navigation, Local Interconnect Network (LIN) and CAN (Controller Area Network), inter-vehicle communication (IVC) protocols. MOST (Media Oriented Systems Transport), FlexRay, and Ethernet have become accepted standards in automotive communications design. Those standards such as Dedicated Short-Range Communication (DSRC) standard are expected to dramatically reduce the number of fatal roadway accidents by providing early warnings and allow safer navigation of the autonomous system.

The aims of the present invention are improving vehicles' control performances by increasing the detectability of low-electromagnetic-profile objects and the information received from those low-electromagnetic-profile objects, by the vehicles' sensors, revealing vital information about the nature, position, speed, etc., of the object, upon a query request from the vehicle, by its radar and an RFID interrogation. Due to its simplicity, high reliability and very low-cost, it can be mounted on every existing or new road element, fixed or moving, providing accurate, reliable, all-weather proof, information to any vehicle and even to multiple vehicles simultaneously. It is integrated into the vehicle's control system enabling it safe and accurate semi or fully automatic navigation.

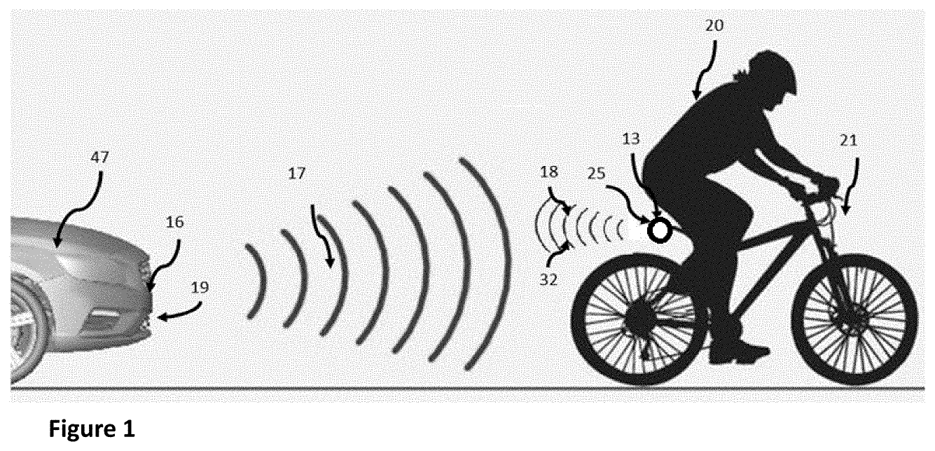

Referring specifically to FIGS. 1 through 15, FIG. 1 illustrates an embodiment of the present invention including a rider 20 on a bicycle 21. The vehicle 47 and its radar 16 and its RFID reader 19 send electromagnetic signals 17. The system of the present invention which includes of a reflector 13 and an RFID transponder 25 sends back the electromagnetic signal, which includes of the reflected radar signals 18 and the response of the RFID tag 32 (i.e., with data).

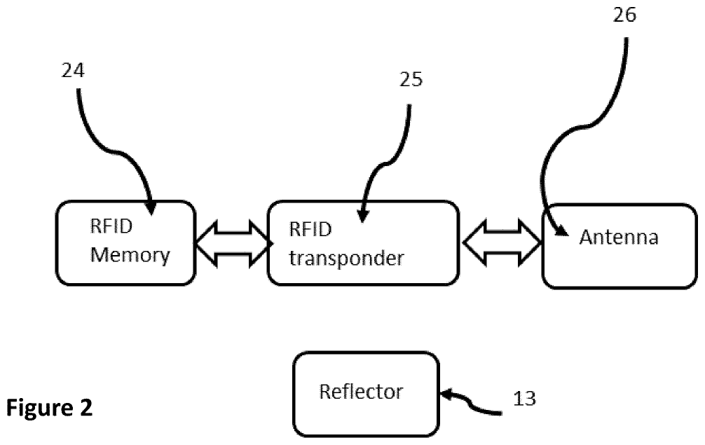

FIG. 2 depicts modules in a passive embodiment of the present invention, including of a reflector such as a the road-sign metal plate itself or a corner reflector 13, and an RFID module which has a memory 24 a transponder circuit 25 and the RFID tag antenna 26.

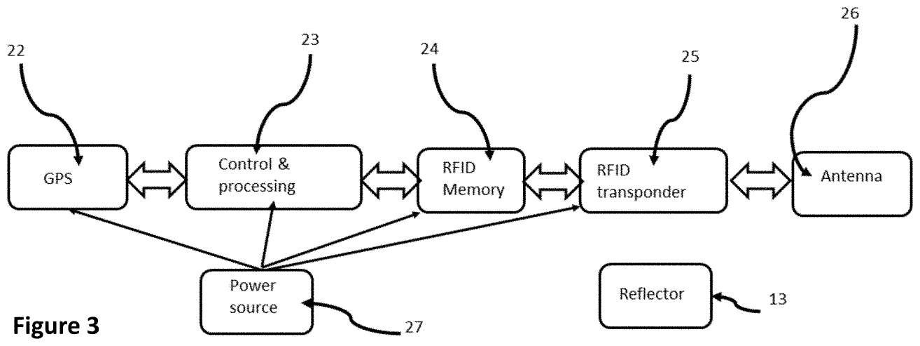

FIG. 3 depicts the main modules in the system of the present invention, it's RFID active version. It includes of a reflector such as the sign itself or a corner reflector 13, and an active RFID module which has a memory 24 a transponder circuit 25 with a powered transmitter and the RFID tag antenna 26. The GPS data 22 is written on the RFID memory 24. The whole device is controlled by a control and processing unit 23 (built-in or external), like a microprocessor or ASIC, and gets its power from a power source 27 a battery, a solar panel, a power line and the like.

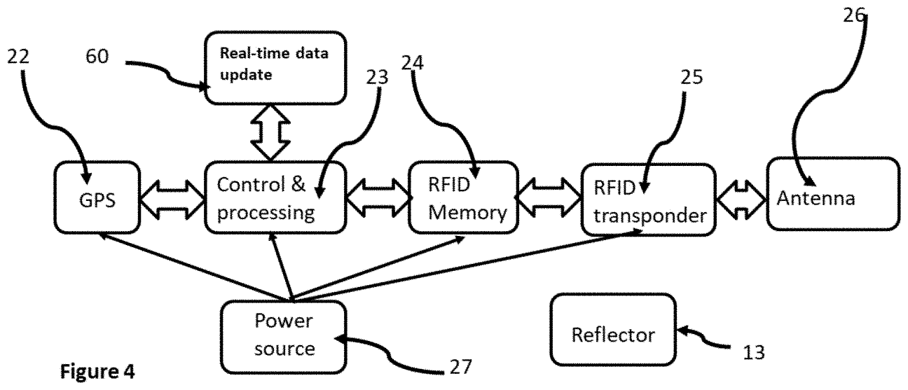

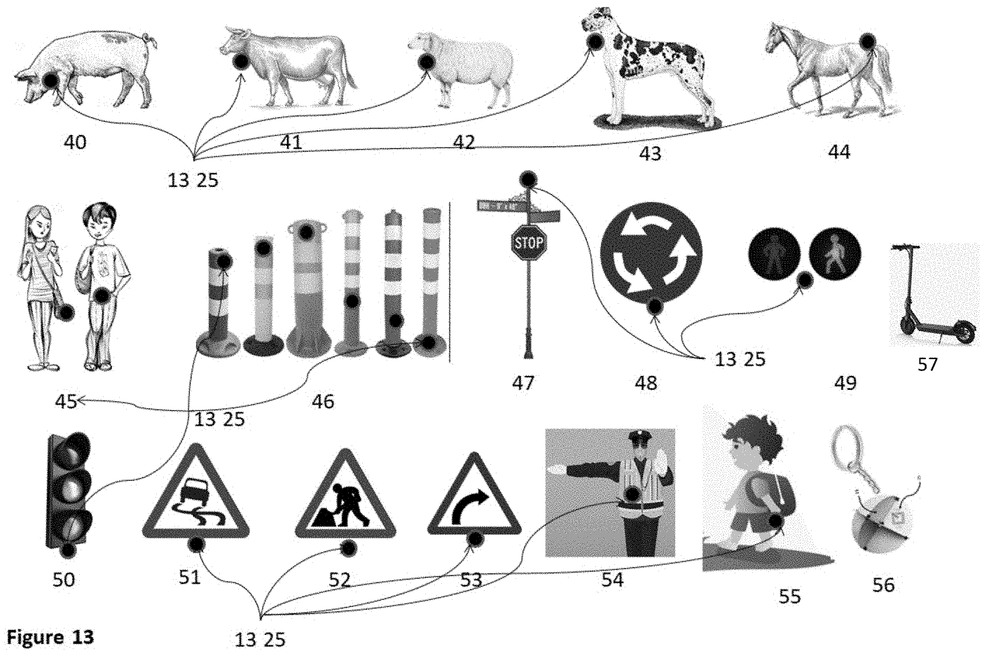

FIG. 4 depicts modules in the system of the present invention, the continuously programmable active (or passive) version. It includes of a reflector such as a corner reflector 13, and an active RFID module which has a memory 24 a transponder circuit with a powered transmitter 25 and the RFID tag antenna 26. The GPS data 22 is fed into the RFID memory 24 and it can be updated upon every change in location at a fast rate, say, several times every second, so even a very fast-moving object will give its accurate location data within a difference of centimeters. Additional information such as traffic-light 50 (in FIG. 13) status can also be updating the RFID memory continuously, where the data is coming from the traffic-light computer (as an example) that update in real-time the status of the traffic light. The whole device is controlled by a control and processing unit 23 and gets its power from a power source 27 a battery, a solar panel, a power line and the like.

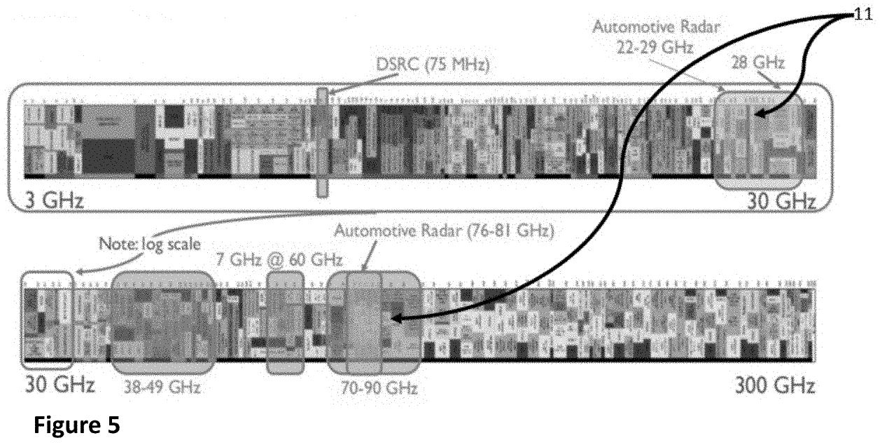

FIG. 5 depicts the current frequency allocation for the automotive industry, including for radars in use by vehicles 11.

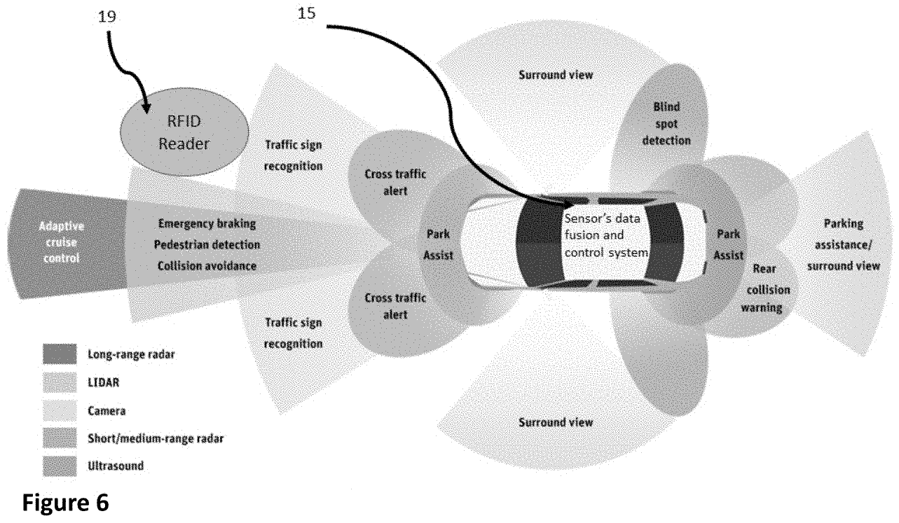

FIG. 6 illustrates the type of sensing technologies and devices of an autonomous (a self-driving) vehicle, or a semi-autonomous vehicle uses to navigate its way. All the data from the sensors flows into a sensor's data fusion and control system 15, which controls the vehicle and its movements. An RFID reader (or interrogator) 19 is added by the present invention, to the array of sensors and its input is an input to the vehicle sensor's data fusion and control system 15 in addition to other multi-sensors inputs.

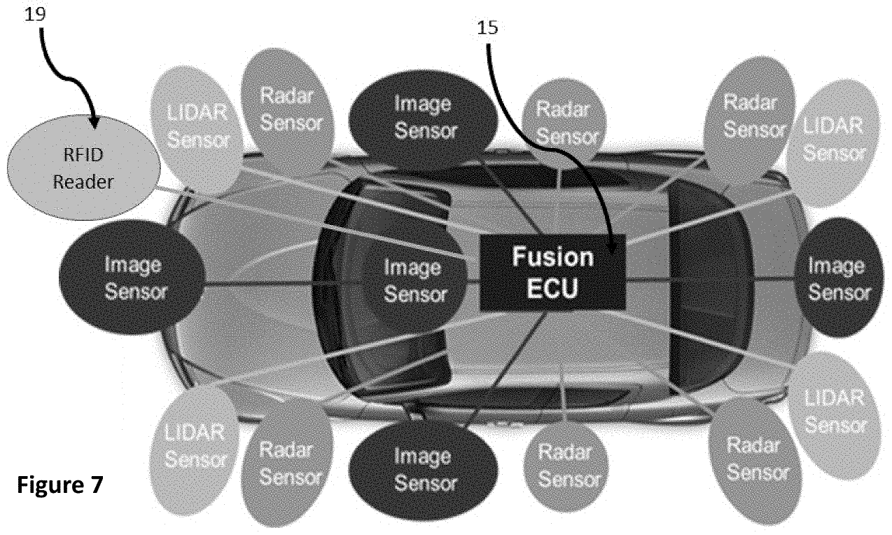

FIG. 7 illustrates the type of sensors uses by an autonomous (a self-driving) vehicle or a semi-autonomous vehicle to navigate. All the data from the sensors flows into a sensor's data fusion and control system 15, which controls the vehicle, also known as Fusion ECU (Electronic control unit) 15. An RFID reader (or interrogator) 19 is added by the present invention, and its input is added to the multi-sensor's inputs to the vehicle control unit 15.

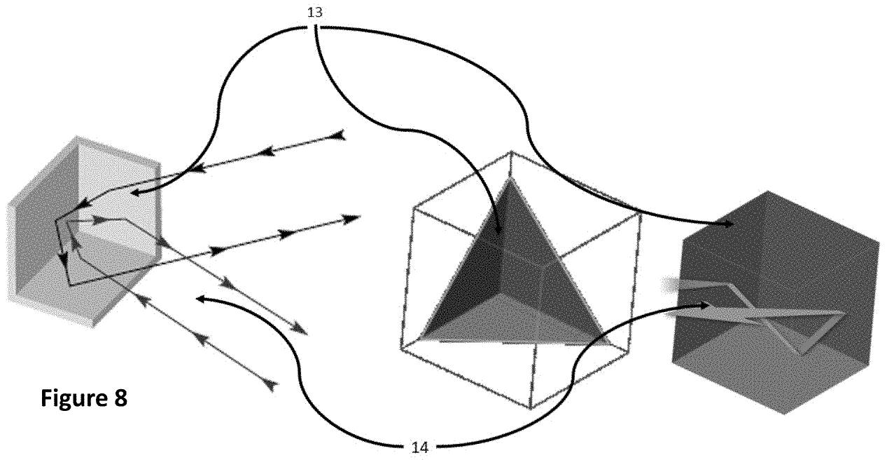

FIG. 8 illustrates in diagram form a general concept of a typical corner reflector 13 and the path an electromagnetic wave travels in the reflectors 14.

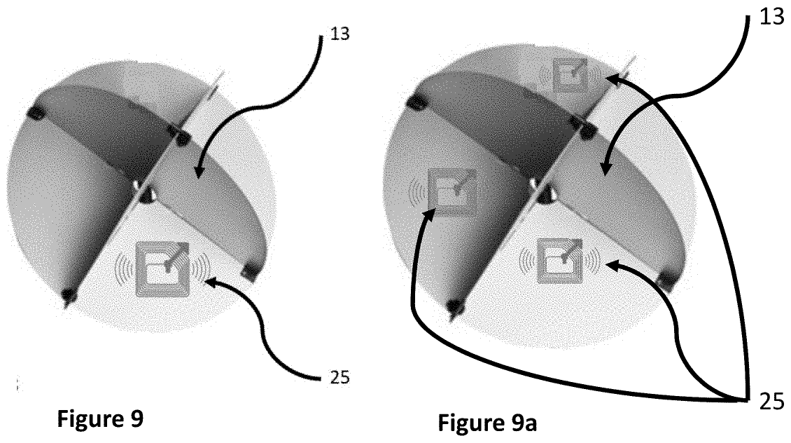

FIG. 9 illustrates in diagram form a general concept of a typical corner reflector 13. As shown, it includes of multiple corner-reflectors that bounce back electromagnetic signals coming from any direction. An additional RFID tag (passive, active or continuously programmable tag) 25 is attached to the reflector 13. The RFID tag is positioned in the preferred corner. The position of the antenna and RFID tag can be fixed and secured by plastic holders or by filling the corner reflector cavity with silicone, plastic or other non-metal materials that hold the antennas in the preferred position, usually the feed position.

FIG. 9a illustrates in diagram form a general concept of a typical multi-directional corner reflector 13. As shown, it includes of multiple corner-reflectors that bounce back electromagnetic signals coming from any direction. An additional RFID tag (passive, active or continuously, programmable tag) 25 is attached to the reflector 13. RFID tags (or the antennas only) are positioned in every corner. The position of the antenna and RFID tag can be fixed and secured by plastic holders or by filling the corner reflector cavity with silicone, plastic or other non-metal materials that hold the antennas in the preferred position, usually the feed position.

FIG. 10 illustrates an example the improvement in the radar cross-section reflection achieved by a corner reflector. It shows the radiation pattern of the triangular trihedral corner reflector in the azimuth and elevation planes.

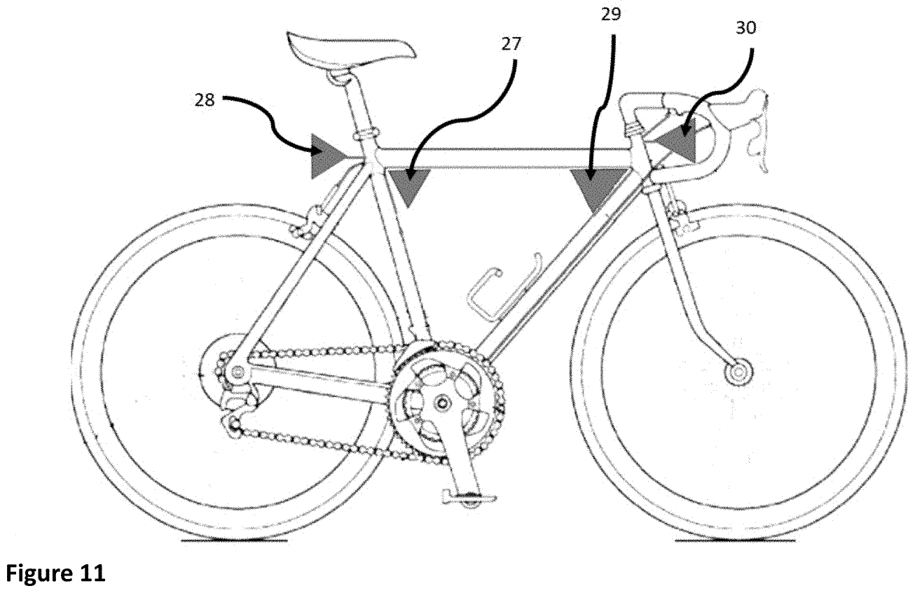

FIG. 11 illustrates in diagram form a general structure of a typical setup of the system of the present invention on a bicycle, as an example for a low electromagnetic profile object. The rear reflector of the system of the present invention 28 aimed for reflecting electromagnetic signals coming mainly from the vehicle behind the bicycles, front reflector 30 aimed for reflecting electromagnetic signals coming mainly from the vehicle in front the bicycles. The two side reflectors 27 and 29 aimed for reflecting electromagnetic signals coming mainly from vehicles on the side or from road-side devices and elements. It should be noted that due to the nature of the reflectors those reflectors can also reflect signals that are coming not directly to the reflectors. RFID tags, passive, active or continuously programmable, (not shown) can be also integrated into either reflector.

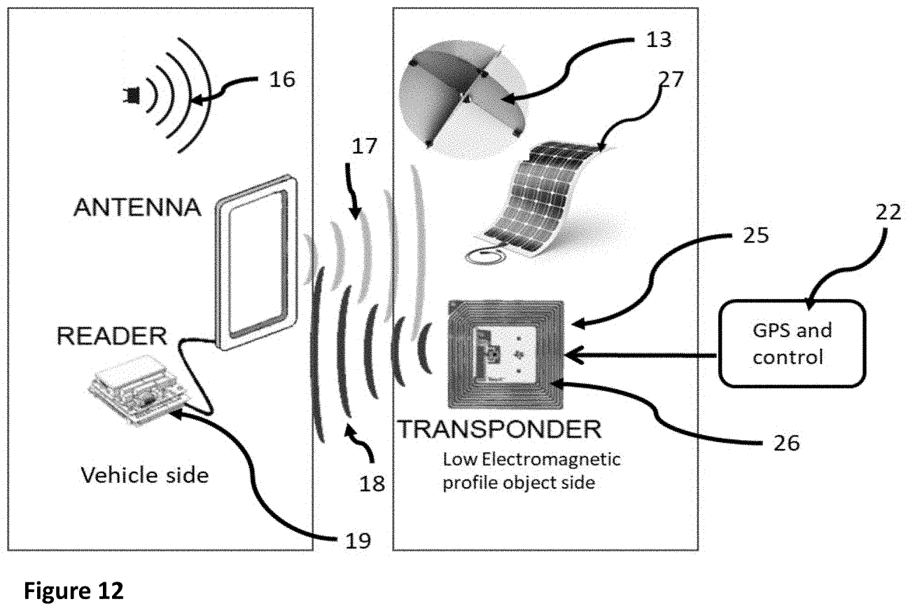

FIG. 12 illustrates in diagram form a general structure of a typical system of the present invention. A radar 16 and a reflector 13, the RFID reader (interrogator) 19, the interrogation signal 17 and the responded signal 18 coming from the transponder 25 and its antenna 26. A GPS 22 can also be connected to the RFID tag. The tag is powered by a power source such as a solar cell, a battery, etc. 27.

FIG. 13 illustrates in diagram form an example of typical objects that a vehicle may encounter while navigating; animals like a pig 40, a bull/cow 41, a sheep 42, a doc (a pet) 43, a horse 44, humans like school teens 45 a policemen 54 and a child 55 and road side objects like a post 46, a stop sign 47 (as an example of road-signs), streets elements like a roundabout 48, a traffic-light for pedestrians 49, a traffic-light for vehicles 50, verity of road-signs 51 52 53 (as an example). The reflector and the RFID can be realized in a keychain 56 and be carried on a bag or belt, mounted on a scooter 57—and the like, and any combination thereof. The reflector 13 and the RFID tag 25 (of any kind) are attached to the objects (shown in the form of a black circle) to increase their visibility, detectability and to provide information to the vehicles.

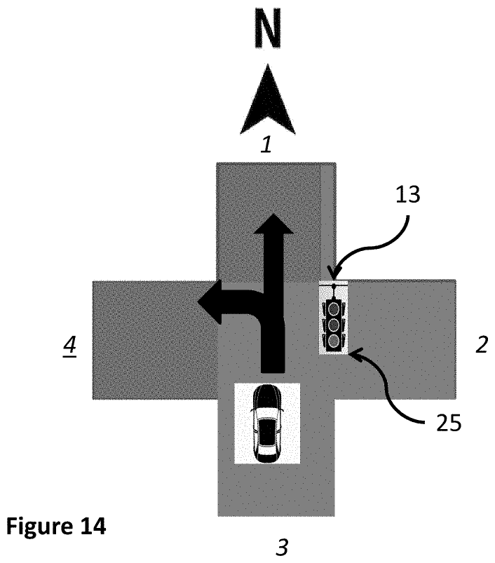

FIG. 14 illustrates in diagram form a general structure of a typical setup of the system of the present invention installed in a traffic-light (as described in the example) where the RFID 25 provides information on the present status of the traffic light to vehicles approaching. It his example the information id that the vehicle can only turn to the left (East) or continue straight (north), and the current status is Green (go ahead). In this example, the traffic-light itself is the radar reflector 13 hence it has a sufficient RCS.

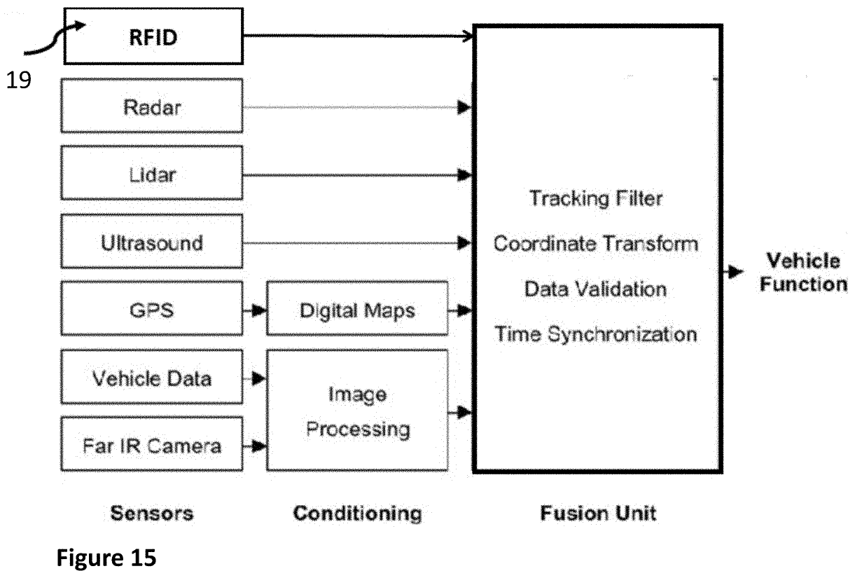

FIG. 15 illustrates in diagram form a general structure of a typical setup of the system of the present invention installed in a vehicle control system. An image processing and digital maps are also part of the guidance system a vehicle control system uses. An RFID 19 reader is added to the vehicle's sensors, conditioning and fusion system, which comprises its control system.

The method of the present invention is based on adding an RFID reader to the set of sensors a vehicle is utilizing for semi or full navigation in the rural or urban environments, as well as adding visibility and detectability enhancing devices (e.g., radar reflectors, RFID tags, etc.) to objects found in such environments. The information provided the system is fed to the vehicle fusion and control unit for processing, control and guidance of the vehicle. This vital information is very accurate vs. the information sensors feed the vehicle control systems (with data on the current and developing state of the vehicle's surroundings). Both operation and safety depend on the accuracy of the sensor system. While in the system of the present invention, the information is set up upon installation at the object or updated by the system in real-time. It reduces significantly the error the vehicle control system may have due to the erroneous analysis of the data it picks. The outcome is much safer navigation.

One of the novelties of the present invention is that while current autonomous (and semi-autonomous) cars rely only on their own sensors and processing capabilities, the disclosed systems and methods of the present invention, add assistance to the vehicle's control system, as objects it encounters “identify” themselves, a) by increasing their “visibility” to the vehicle's sensors by increasing their radar cross section and b) by providing vital information about their nature such as what are they; a child, a road sign meaning a right curve ahead, their accurate position, status, and the like.

As shown in FIG. 1, a vehicle 47 is equipped with multiple sensors for semi or full autonomous navigation; among those sensors are a) vehicle's radar 16 and b) an RFID reader 19. Both send electromagnetic signals; the radar 16 for the detection of an object(s) in front of the radar (or on one side of the vehicle) and an RFID reader 19 to interrogate it/them and get as reply information about their type (or nature), position, etc. A bicycle 21, as an example of an object with a low-electromagnetic profile, and its rider 20 reflects radar pulse back, yet, typically it responds by a very weak response signal to the radar signal 17 (what is also known as low Radar Cross Section). The system of the present invention includes of a reflector 13, like a corner reflector (see FIG. 8) and an RFID transponder 25. The radar signal is bounced back as a much stronger signal 32 (due to the structure of a reflector—see FIG. 10) 18 and is received at the radar as a big object. The RFID interrogation signal is responded by the RFID tag 25 (either active or passive) and sends back a signal 18 that contains information about the nature (or type) of the object (it is attached to), and optionally its real-time position, hazards that may be relevant to the specific object, serial number, material composition, age, size, weight, height, and any combination thereof, based on an agreed protocol. A block diagram of the system of the present invention is depicted in FIG. 2, showing the RFID in its passive version. The RFID memory holds the data the RFID tag should respond to interrogation. The transponder 25 holds the electronic circuitry needed to respond to an interrogation from the RFID reader. The antenna 26 transmits the response back to the RFID reader. The RFID is attached to a reflector like a corner reflector. Together the RFID and the radar reflector enhance the visibility of the object to a vehicle and give vital information to the vehicle control system for a saver movement.

The same concept is depicted in FIG. 3, but here the RFID is an active tag, having the advantages of longer responds range (usually up to 300 meters) and possible control over the transmitted data and even notify the object (like the bicycle rider) on the approaching vehicle. The transmitted data can be modified by a control unit 23, and the content of the RFID tag memory 24 can be updated with information about the current position of the object as provided by a GPS unit 22 to the RFID transponder 25 and its antenna 26 and reflector 13. The system is powered by a power source 27 such as a battery or a solar cell (photovoltaic as an example).

An additional embodiment, an optional configuration the reflector is as part of the antenna for the RFID. The current frequencies allocated for vehicle radars are given in FIG. 5.

The system of the current invention requires adding an RFID reader 19 to the array of sensors that are connected to the vehicles' sensors-data fusion and control system 15 (as shown in FIGS. 6, 7 and 15).

The system can read multiple objects simultaneously and the objects can respond to multiple interrogations in a very short time and even simultaneously.

An example of a corner radar reflector, a corner reflector 13 principal operation concept 14 is depicted in FIGS. 8 and 9. As shown, it bounces back the incoming signal from most directions, thus giving a very high return signal to the radar. The RFID tag 25 is attached to the reflector 13, creating together an effective system for enhancing the visibility and detectability of objects with a low-electromagnetic profile, as demonstrated in FIG. 9.

An example of the system of the present invention as installed on a bicycle is given in FIG. 11. It can be placed in various places on the bicycle, in a way that it does not interfere with the riding but gives good visibility and detectability in either direction. The system can be either passive or active.

Example of objects that can benefit from the system of the present invention is given in FIG. 13 and includes; livestock animals, pigs, cows/bulls, sheep, pets, horses, children, road-side posts, traffic light, policeman, children, and the like, of course in any combination.

### Continuously-Programmable RFID

Another embodiment of the present invention is a Continuously-Programmable RFID, where the information on the tag is updated frequently and continuously as the parameters of the object it is attached to changes such as location, speed, etc. Such an RFID tag chip can include:
(a) Single memory (where the ID, i.e., its data). The processor writes the new data (like updated GPS coordinate, traffic light status, etc.) as needed, say once every second as an example. During the writing time, which typically takes few microseconds, the tag is not responsive to the reader's, however, the writing time VS. The overall time is very low (i.e., the ‘duty-cycle’), thus making the tag responsive in most of the time.
(b) A double-buffer memory setup, where two memories serve in an alternating manner, while one is being used to respond to a query by a tag reader, the other memory is updated with the updated data (i.e., in ‘writing-mode’). Those memories alternate and swap tasks, leaving one memory, with the most updated data, ready for use all the time.
   Both versions allow updating the ID data continuously with real-time information.

Continuously-Programmable RFID tags life-time is virtually almost unlimited. Current memory technologies (like F-Mem) with 10 billion read & write accesses, enable almost unlimited ‘write’ operations to a tag's memory. It means that one can update the object's position every fraction of seconds. As an example, an object's position can be updated every ten milliseconds (as an example)—an equivalent to less than a foot in traveling distance to a vehicle driving at 100 Km/Hr.) and still have a lifetime of many years.

Another embodiment of the present invention is that it can be implemented on a limited scale if needed (due to budget etc.). As an example, an autonomous vehicle traveling in a fixed and predefined track, like public transportation lanes. Adding the capabilities described in the present invention to a limited number of objects in a limited track simplifies the overall system cost, improves significantly its safety and leave the vehicle's other sensors and radars to focus on only unexpected, spontaneous and unknown events and objects that the vehicle encounters while traveling.

### Anti-Collision Protocols and Algorithms

The RFID reader can employ algorithms for anti-collision, which enables the simultaneous reading of multiple RFID tags, for a situation the vehicle may face in a congested traffic and environment with multiple objects.

The anti-collision protocols can be broadly classified into four multiple access protocols.
a) SDMA—In space division multiple access. The channel is divided directionally by using either directional antennas or multiple readers for the identification process. For the spatial separation of the channel, this protocol requires complex antenna design.
b) FDMA In frequency division multiple access. Instead of dedicating the whole channel to a single communication link, the channel is divided into smaller bandwidths. Each frequency region is dedicated to a single tag until the identification is over. This mechanism requires complicated reader functionality to perform successful identifications.
c) CDMA In code division multiple access. The tags are required to multiply their ID with a pseudo-random code before transmitting it to the reader. The reader then decodes the transmitted ID by matching them with a unique code. This system requires intricate functionality on both ends because of the computational work that needs to be done for the successful identification process.
d) TDMA in time division multiple access. The channel bandwidth is divided into time slots which is used by the tags and the reader for the communication process. TDMA protocols forms the largest family of anti-collision protocols for passive RFID systems because of its ease of implementation and reduced complexity. TDMA systems can be further divided into reader-driven systems also known as Reader-talk-first (RTF) and tag driven systems also known as Tag-talk-first (TTF).

Anti-collision algorithms to be mentioned (as an example of) are: ALOHA, framed slotted Aloha (FSA), Dynamic Frame Slotted ALOHA (DFSA), progressing scanning (PS) algorithm, and tree-based protocols as probabilistic and deterministic approaches respectively.

TABLE NO 2
A summary of the tree-based protocols

| | | | | Bitwise |
|---|---|---|---|---|
| | | Tree | Binary | Arbitra- |
| Crite- | Query Tree | Splitting | Search | tion |
| rion | (QT) | (TS) | (BS) | (BTA) |
| Protocol | The reader | By splitting | The reader | Every tag |
| feature | transmits a | collided tags | sends a serial | responds in |
| | query and the | into disjoint | number to the | a bit by bit |
| | tags with pre- | subsets, the | tags and those | manner |
| | fix matching | collisions are | with values | |
| | the query | resolved | less than or | |
| | respond. | here. | equal to the | |
| | | | serial number | |
| | | | reply. | |

| | |
|---|---|
| RTF/TTF | Reader driven system |

TABLE NO 3
A comparison between tree and ALOHA based protocols

| Criterion | Tree protocols | ALOHA protocols |
|---|---|---|
| Protocol | These protocols operate | These protocols require |
| feature | by grouping responding | tags to respond randomly |
| | tags into subsets and | in an asynchronous manner |
| | then identifying tags in | or in synchronous time |
| | each subset Sequentially. | slots or frames. |
| Frequency | Mainly UHF and micro- | LF, HF and UHF |
| | wave | |
| Reader to tag | High | Low |
| commands | | |
| Efficiency versus | Higher efficiency is | Lesser efficiency in high |
| tag density | achievable in high tag | tag density |
| | density | |
| Method | Deterministic | Probabilistic |
| Optimum channel | 43% | 18.4% (PA), 36.8% |
| utilization | | (BFSA) & 37% (DFSA) |

Reference: Arundhoti Ferdous, “Comparative Analysis of Tag Estimation Algorithms on RFID EPC Gen-2 Performance” Scholar Commons Citation, 2017.

### Examples of the Present Invention

Fixed positions objects (like roadside elements, roundabout, telephone post, electric-grid posts, road signs, and the like) can be incorporated into the system of the present invention and have their position set up upon installation. A technician programs the RFID tag with the location (coming from a GPS as an example) where he/she placed the road-sign (as an example). The RFID attached to the road-sign will transmit to an interrogator its ID as well as its accurate position. A vehicle applying radar and an RFID reader can get accurate information from those, surrounding objects, identify their nature, and their real-time position by a simple operation. The accurate information is fed to the vehicle control unit that guides the vehicle safely. It eliminates the need for complex processing and/or errors in identifying such objects if one relies only on the vehicle's sensors data, a crucial addition for a vehicle's safe navigation.
a) An example of a passive RFID installed inside a child's schoolbag, with a radar reflector.

| | Type of road | | | | |
|---|---|---|---|---|---|
| | element | ID number | Height | RCS | Material |
| Examples of | A pedes- | 0987654321 | small | Low | Human |
| data within | trian - | | | | (flesh & |
| the RFID tag | child | | | | blood) |

The information is coded to internationally
agreed codes (an example of)

| | | | | | |
|---|---|---|---|---|---|
| Example of | 300 | 9720987654321 | 002 | 001 | 001 |
| digital code | | | | | |

This tag information means: It is a small child, with a low RCS, located in Israel with an RFID tag no. 0987654321.
b) An example of an active RFID installed inside a road-sign that a lane is blocked:

| | Type of | | | | | | Lane |
|---|---|---|---|---|---|---|---|
| | road | | | | | | block |
| | element | ID number | Height | RCS | Material | Position | starts in |
| Examples | Road-sign - | 09876543217654321 | 6 feet 2″ | Low | Steel | 40.748440, | 100 |
| of data | Closed lane | | | | | −73.984559 | |
| within | | | | | | | |
| the RFID | | | | | | | |
| tag | | | | | | | |
| Example | 0987 | ∫09876543217654321 | 00602 | 001 | 002 | 40.748440, | 100 |
| of digital | | | | | | −73.984559 | |
| code | | | | | | | |

This tag information means: It is a road-sign made of steel, which warns that in 100 yards from the position of the road sign the lane is closed.

Due to the active nature of the RFID, the detection range is much longer (usually about 300 meters).
c) Two examples of an RFID installed on a traffic light with a continuously—programmable RFID (where the data is updated continuously).

### Example No. 1

Objects like traffic-lights that deliver to the driver (nowadays) only information if it can cross the junction (‘green-light’) or it must stop (‘red-light’) and the direction it can drive. However, with the system and method of the present invention, as an example, will update the data in its RFID tags with additional information (to be picked up by the vehicles RFID reader) on the traffic-light current status; which lanes can be used (‘green-light) in which lanes it has to stop (‘red-light’), elapsed time from last change, due time to next change (i.e., switching lanes), and the like.

In a traffic-light as an example, the data transferred by the RFID upon interrogation by the vehicle's RFID reader is the interpretation of the numerical information is in accordance with agreed standard and may differ from one element to the other. (excluding pre-ambles, sync, and other non-data bits); as an example,

| | Type of | Traffic- | | | | | | | | |
|---|---|---|---|---|---|---|---|---|---|---|
| | road | light ID | GPS | Junction | Position | Driving | Current | Elapsed time | Due time | |
| | element | number | coordinate | type | at junction | options | Status | from the change | to change | Material |
| Examples of | Traffic- | US1234567890 | 40.748440, | 4-ways | 2 | 4, 1 | Green | 12″ | 28″ | Plastic, |
| data within | light | | −73.984559 | | | | | | | ferro- |
| the RFID tag | | | | | | | | | | metal |

The information is coded to internationally agreed codes (an example of)

| | | | | | | | | | | |
|---|---|---|---|---|---|---|---|---|---|---|
| Example of | 100 | 0011234567890 | 40.748440, | 002 | 2 | 4, 1, 0 | 02 | 12 | 28 | 005, |
| digital code | | | −73.984559 | | | | | | | 002 |

This tag information means: This is a traffic-light located in the United States, position at N40° 44.9064′, W073° 59.0735′ (Empire State Building in New York City). It is a 4-way junction; the traffic-light is positioned at the south end of the junction, a vehicle can turn to the left or drive straight (I.e., no right turn allowed). Its current status is Green (means driving is allowed), the green-light is ON for 12 seconds and will be ON in the next 28 seconds. It is made of plastic and ferrometals. (See in FIG. 14). The information will be updated every second in the RFID-tag memory and/or upon a change in the traffic light status (green to red as an example).

### Example No. 2

A bicycle, as an example, the data transferred by the RFID upon interrogation by the vehicle's RFID reader is, as an example.

| | Type of | | | | | | | |
|---|---|---|---|---|---|---|---|---|
| | road | | GPS | | Driving | | | Special |
| | element | ID number | coordinates | Speed | direction | RCS | Material | warning |
| Examples of | Bicycle | US987654321 | 40.748440, | 25 Km | 270 | Low | Carbon | Disabled |
| data within | | | −73.984559 | Hr | degrees | | fiber | |
| the RFID tag | | | | | (vs. the | | | |
| | | | | | north) | | | |

The information is coded to internationally agreed codes (an example of)

| | | | | | | | | |
|---|---|---|---|---|---|---|---|---|
| Example of | 200 | 001987654321 | 40.748440, | 25000 | 270 | 001 | 010 | 033 |
| digital code | | | −73.984559 | | | | | |

This tag information means: This is a carbon-fiber made bicycles, with a low Radar Cross Section, driving sped is at 25 kilometers per hour in the direction of 270 degrees from north (i.e., westward), and has special warning as it is for a disabled user. The information about the position of the bicycle and its speed is updated at the tag ten times per second (as an example).
Another embodiment of the disclosed systems and methods of the present invention is it Encryption and cyber-security;
Encryption and security measure that will guarantee accurate information with no optional access by malicious elements (cyber-attack). It can be added to the RFID tags and be deciphered by the reader and checked for authenticity. The encryption method can be adapted to any version of the RFID tags.
Cyber proof characteristic. Hence it is based on a one-way communication (RFID reader interrogation is not regarded as ‘communication’), no cyber attach can affect directly the RFID tag data and change it in any way. Indirect cyber-attack, via the traffic-light computer system, as an example, can and will be prevented by the traffic-light system itself. The RFID tag data is not subject to any direct cyber-attack.

Additional Aspects of the Present Invention
a) ID—The ID can be a unique ID as MAC (Media Access Control) number is unique in communication of computers systems and is linked to every physical MAC, so can every object be identified by a unique ID.
b) Cyber protection—Another embodiment of the disclosed systems and methods of the present invention is it embedded cyber proof characteristic. As a pre-programmed tag, no cyber attach can affect directly the RFID tag data and change it in any way. Indirect cyber-attack, via the traffic-light computer system, (for programmable tags) as an example, can and will be prevented by the traffic-light system itself. The RFID tag data is not subject to any direct cyber-attack.
c) Parking assistance—Another embodiment of the disclosed systems and methods of the present invention is as parking assistance where the reflector 13 and the RFID provide information to the parking vehicle on objects next to the requested parking slot.
d) Internationally agreed RFID protocol(s)—It is a goal that the international community will adopt a unified protocol (or protocols) that will be used in any RFID attached to low-electromagnetic objects and be accessible and readable by any vehicle in any place around the world.
e) Non-intelligent vehicles—The system of the present invention can also be installed on non-intelligent vehicles, even though they are not a road element with the low-electromagnetic profile.
f) Reducing processing power—An additional effect of the disclosed systems and methods of the present invention is that vehicles will be able to analyze their surrounding objects more efficiently sparing some of the massive processing power needed to collect, analyze, and interpret data based on sensor's data only thus reducing misinterpretation of the surrounding status significantly. Reducing the processing power and sensor's complexity of vehicle (semi/full autonomous).
g) An additional effect of the disclosed systems and methods of the present invention is that vehicles RFID reader can employ algorithms for anti-collision, which enables the simultaneous reading of multiple RFID tags, for the situation the vehicle may face in congested traffic and an environment with multiple objects.

It should be understood, of course, that the foregoing relates to exemplary embodiments of the invention and that modifications may be made without departing from the spirit and scope of the invention as set forth in the following claims.

What is claimed is:

1. A method for improving a vehicular navigation control system, comprising:
providing a vehicle having a navigation control system;
connecting an RFID reader to the vehicle and operatively associated to said navigation control system; and
attaching one or more reflectors to at least one object having a low radar cross-section, wherein each reflector increases the radar cross-section;
coupling one or more RFID tag to each object, wherein each RFID tag retrievably stores an identification data comprising a nature of the said object; and
said nature being irrespective of a position of said object,
wherein the RFID reader is configured to interrogate every RFID tag within an operable range so that the RFID tag discloses the identification data.

2. The method of claim 1, wherein the one or more RFID tag is passive, powered by the interrogating RFID reader.

3. The method of claim 1, wherein the one or more RFID tag is self-powered.

4. The method of claim 1, wherein the one or more RFID tag is configured to retrievably store a positional data.

5. The method of claim 4, wherein the one or more RFID tag is continuously programmable so that the positional data is updated a plurality of times per second.

6. The method of claim 5, wherein the one or more RFID tag provides double buffer memory.

7. The method of claim 1, further comprising an antenna operatively associated with each of the one or more RFID tag.

8. The method of claim 7, further comprising a plastic holder securing the antenna and the one or more RFID tag to the reflector.

9. The method of claim 1, wherein each reflector is a corner reflector.

10. The method of claim 1, wherein the RFID reader utilizes anti-collision algorithms enabling simultaneous reading of multiple RFID tags.

11. A method of creating a vehicular ad-hoc network, comprising:
providing a plurality of vehicles incorporating the method for improving a vehicular navigation control system of claim 1; and
each navigation control system configured to share the identification data of each object with each vehicle beyond the operable range.

12. The method of claim 11, comprising:
a traffic module coupled to each navigation control system, wherein the traffic module comprises a status of traffic regulation in the operable range, and wherein the traffic module is coupled to the identification data of each object.
